(19) United States
(12) Patent Application Publication
(10) Pub. No.: US 2010/0282183 A1
(43) Pub. Date: Nov. 11, 2010

(54) Flat Ring Pet Collar and Methods of Use

(76) Inventor: Gary Lennox, Westminster, CO (US)

Correspondence Address: Leyendecker & Lemire, LLC, Suite 280, 9137 E Mineral Circle, Centennial, CO, 80112, US

(21) Appl. No.: 12/436,295

(22) Filed: May 6, 2009

(51) Int. Cl. A01K 27/00

(52) U.S. Cl. 119/792; 119/863

(57) ABSTRACT

A pet collar with a flat-sided ring that tends to remain in position proximate a pet's dorsal neck is described. Methods of use, with the pet collar installed on the pet with a flat side of the flat-sided ring disposed on the inside of the pet collar against the fur or skin of the pet, are also described.

### FIELD OF THE INVENTION

The present invention relates generally to pet collars and methods of their use.

### BACKGROUND

People place collars on dogs and other pets in order to, among other things, provide a means for attaching a leash or tether, and for holding tags such as vaccination and registration tags. Such collars typically comprise an attachment ring for attaching the leash or tether, and tags are frequently affixed to the attachment ring as well.

It is often desirable to attach a leash to a collar proximate an animal's withers or back of the neck (dorsal neck) area, rather than proximate the animal's throat. Where the leash attaches proximate the animal's withers, the animal is less likely to step over, onto, or become entangled in, the leash. Conversely, where the leash attaches proximate the animal's throat, the animal is more prone to stepping over the leash such that the leash runs beneath the animal's body, and to stepping on or becoming entangled in the leash.

Because a pet collar is generally able to revolve around a dog's neck, a leash attachment point can, and often does, slide around to the dog's throat after a few minutes use, even when the attachment point is initially positioned at or proximate the dog's dorsal neck. Weight of an attachment device such as a snap, and sometimes dog tags as well, can make a conventional pet collar ring a heaviest part of the collar when the snap and tags are fastened to the attachment ring. The heaviest part has a tendency to migrate to a lowest point due to gravitational pull, the lowest point being generally proximate the dog's throat when the dog is standing, walking, or running. Consequently, the attachment ring and snap frequently end up proximate the dog's throat after a few minutes use.

Harnesses with multiple straps that also go around a dog's shoulders can be effective at keeping an attachment ring disposed proximate the dog's withers rather than proximate the dog's throat. However, a collar is preferable to a harness under many circumstances, and a harness is sometimes inappropriate despite its advantage of keeping an attachment ring favorably disposed.

### BRIEF DESCRIPTION OF THE DRAWINGS

FIG. 1 is a top, plan view of a flat ring pet collar according to one embodiment of the present invention.

FIG. 2 is a cross-section of a flat-sided ring according to one embodiment of the present invention.

FIG. 3 is a perspective view of a flat ring pet collar installed on a dog, according to one embodiment of the present invention.

FIG. 4 is a top, plan view of a flat ring pet collar according to one embodiment of the present invention.

FIG. 5 is a cross section view of flat-sided rings according to embodiments of the present invention.

### DETAILED DESCRIPTION

Embodiments of the present invention include a flat ring pet collar comprising a ring with a flat or concave side. The flat or concave side is adapted to reside against a dog's body when the flat ring pet collar is worn around the dog's neck. The flat ring pet collar is preferably placed on the dog with the flat-sided ring disposed at the dog's dorsal neck, proximate the dog's withers, which is generally 180° around the collar from the dog's throat. So disposed, the flat ring pet collar resists revolving on the dog's neck, and the flat-sided ring therefore tends to stay at the dorsal neck, rather than moving around to the throat area.

The flat ring pet collar also tends to stay in place at the dog's dorsal neck when a leash or tether is attached to the flat-sided ring. With the leash or tether attachment at the dog's dorsal neck rather than the throat, the leash is less likely to get stepped on or entangled in the dog's legs.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct connection between the identified elements, components, or objects. Often the manner of the coupling will be related specifically to the manner in which the two coupled elements interact.

The term “ring,” as used in this specification and appended claims, refers to a curvilinear, polygonal, or combination curvilinear and polygonal peripheral band that forms a closed path structure around, and thereby circumscribes, an aperture. Examples include, but are not limited to, circles, ovals, ellipses, rectangles, octagons, hexagons, and combinations thereof.

The term “flat-sided ring,” as used in this specification and appended claims, refers to a ring in which a side of the peripheral band cross-section is flat or concave. Angles where another side of the peripheral band cross section and the flat or concave side of the cross-section meet are 110° or less. The angles are preferably between 60° and 110°, and most preferably about 90°.

The term “fastener,” or “fasteners,” as used in this specification and appended claims, refers to structures that reversibly fasten ends of collars together, or are adapted to reversibly fasten ends of collars together. Where the ends of a collar are fastened together, the collar forms a continuous loop. Fasteners include structures such as, but are not limited to, buckles, clasps, hasps, or snaps. For the purposes of this application, a flat sided ring is not a fastener, and buckles or similar structures adapted to adjust collar size are not flat sided rings.

The term “terminus,” as used in this specification and appended claims, refers to an end of a collar strap or segment thereof.

The term “pet,” as used in this specification and appended claims, refers to animals commonly kept as pets, including, but not limited to, dogs, cats, ferrets, hamsters, and guinea pigs.

The term “dorsal neck,” as used in this specification and appended claims, refers to an area of a neck of an animal also known as back of the neck. The dorsal neck resides on an animal's dorsal side.

The term “tether,” as used in this specification and appended claims, refers to a leash, rope, chain, or similar device adapted to attach to a pet collar, and thereby serve to control or restrain a pet.

The terms “ellipse,” or “elliptical,” as used in this specification and appended claims, refers to a plane curve such that the sums of the distances of each point in its periphery from two fixed points, the foci, are equal. It is a conic section formed by the intersection of a right circular cone by a plane that cuts the axis and the surface of the cone. A circle has an elliptical shape and is an ellipse.

### A First Embodiment Flat Ring Pet Collar

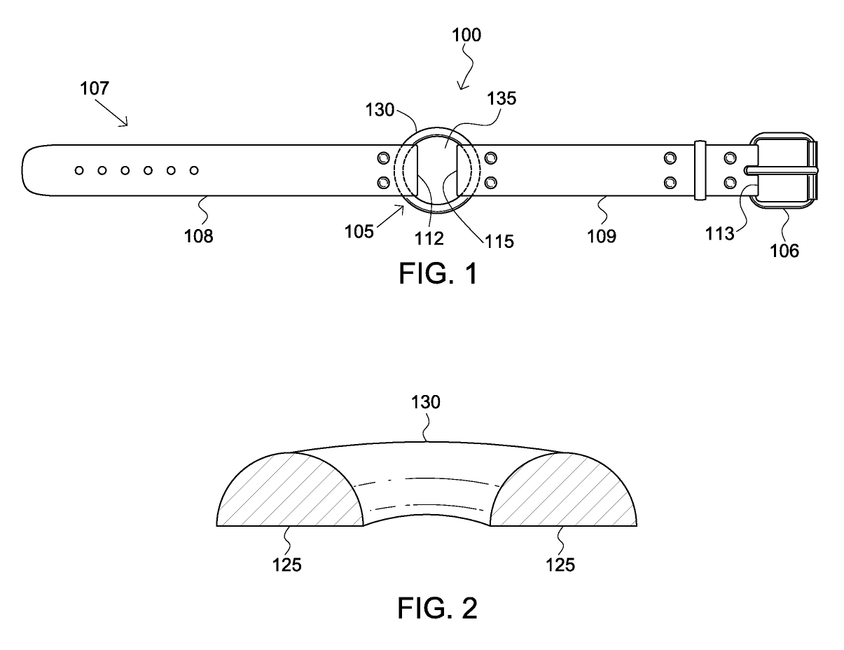

A first embodiment flat ring pet collar 100 is illustrated in FIGS. 1-3. The first embodiment flat ring pet collar comprises a flat-sided ring 105, a fastener 106, and a flexible strap 107 comprising a first segment 108 a second segment 109. The first and second segments comprise a first terminus 112 and a second terminus 115, respectively. The flexible strap of the first embodiment consists essentially of leather. Other embodiments include flexible straps comprising natural and synthetic materials such as, but not limited to, cotton, hemp, sisal, nylon, polyester, polyolefins, other polymers, and combinations thereof.

The flat-sided ring 105 is directly coupled to each of the first segment 108 and the second segment 109 proximate the first terminus 112 and second terminus 115, respectively. The second segment further comprises a third terminus 113, with the fastener 106 being directly coupled to the second segment proximate the third terminus. The fastener of the first embodiment flat ring pet collar is a buckle.

The flat-sided ring 105 comprises a peripheral band 130 that circumscribes an aperture 135. The aperture of the first embodiment flat-sided ring is circular. Other embodiments comprise apertures that include ovals, ellipses, rectangles, octagons, hexagons, other curvilinear or polygonal shapes, or combinations thereof. Where the first embodiment flat ring pet collar is oriented with the flexible strap laying substantially flat in a plane, as illustrated in FIG. 1, the peripheral band of the flat-sided ring also lays substantially flat in the plane.

As best illustrated in a cross-section view shown in FIG. 2, the peripheral band 130 of the first embodiment flat ring pet collar comprises a flat side 125. Other embodiments comprise a flat or concave side. The flat side is preferably between 1.75 and 10 mm across, more preferably between 2.5 and 5 mm across, and most preferably about 4.0 mm across. The flat side is not visible in the top view provided by FIG. 1 because the flat side resides at the bottom of the peripheral band of the flat-sided ring 105 in the first embodiment.

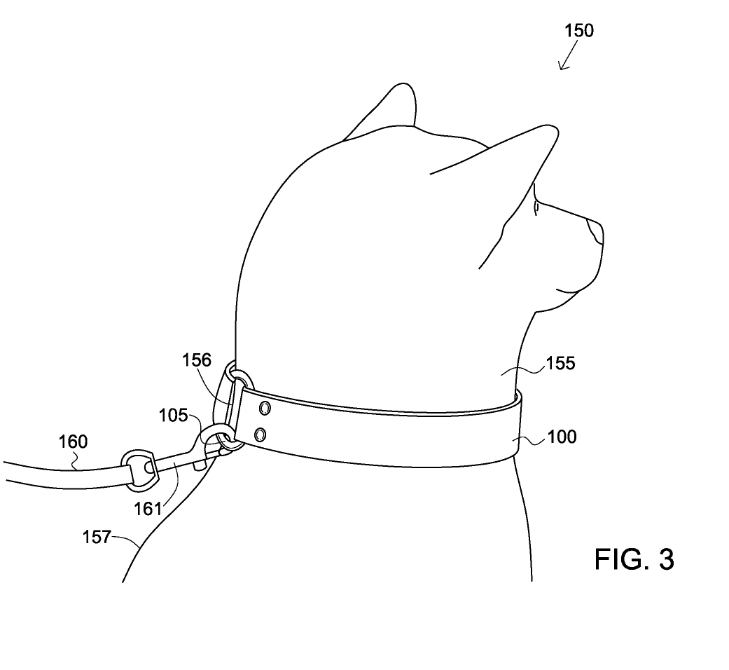

As shown in FIG. 3, the flat ring pet collar 100 is installed on a dog 150, forming a loop around a neck 155 of the dog. With the collar properly installed on the dog, the flat side of the flat-sided ring 105 resides on an inner side (facing in toward the dog's neck). The flat ring collar is oriented in a preferred orientation with the flat-sided ring disposed at the dog's dorsal neck 156, proximate the dog's withers 157. A tether 160 is attached to the flat-sided ring by use of a snap 161. The flat ring collar tends to stay in the preferred orientation with the tether attached, despite added weight of the tether and snap. Conversely, prior art collars are prone to sliding around so that a tether attachment point resides proximate the dog's throat, an undesirable position.

### A Second Embodiment Flat Ring Collar

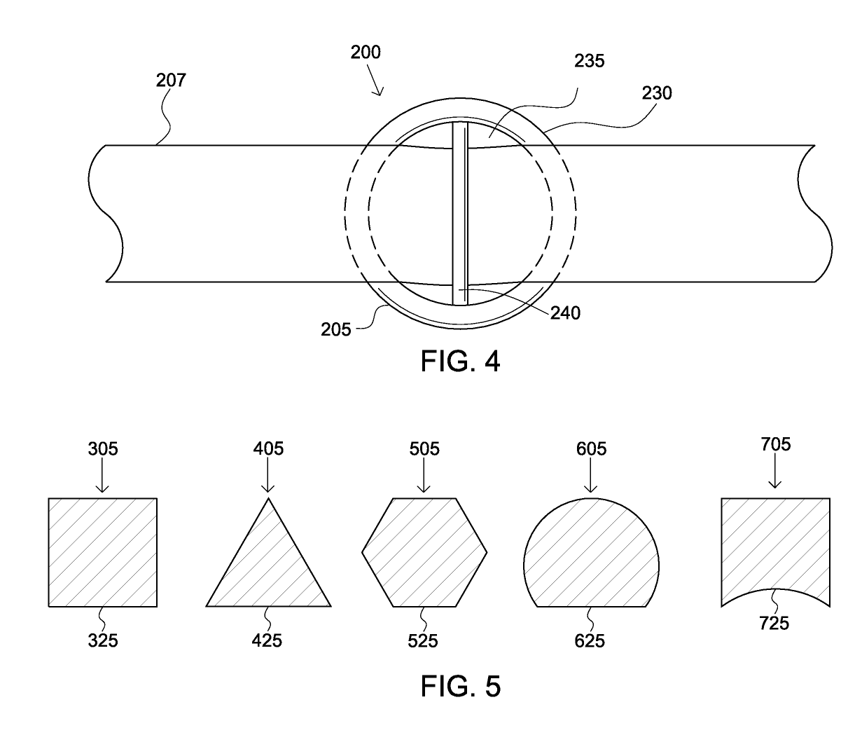

A second embodiment flat ring collar 200, illustrated in FIG. 4, comprises a flat-sided ring 205 through which runs a flexible strap 207. The flat-sided ring of the second embodiment comprises a peripheral band 230 that circumscribes an aperture 235, and a transverse band 240 that bisects the aperture. The flat-sided ring further comprises a flat side that is not visible in the top view provided by FIG. 4 because the flat side resides at the bottom of the flat-sided ring.

### Other Embodiments of Flat-Sided Rings

Cross-sections of peripheral bands of other embodiments of flat-sided rings 305, 405, 405, 605, 705 are illustrated in FIG. 5. The cross-sections shown are at a single point on each of the peripheral bands. Each of the flat-sided rings comprises a flat or concave side 325, 425, 525, 625, 725. Embodiments of peripheral bands of flat-sided rings have shapes that are curvilinear, polygonal, or combination curvilinear and polygonal.

### Alternative Embodiments and Variations

The various embodiments and variations thereof, illustrated in the accompanying Figures and/or described above, are merely exemplary and are not meant to limit the scope of the invention. Some embodiments of flat ring pet collars comprise flat-sided rings with cross-sections having shapes than shown in the accompanying Figures above. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A pet collar comprising:
a flexible strap; and
a flat-sided ring, the flat-sided ring (i) comprising a peripheral band, the peripheral band having a flat or concave side, and (ii) being coupled to the flexible strap.

2. The pet collar of claim 1, wherein the flexible strap comprises a first segment and a second segment, each of the first and second segments being coupled directly to the flat-sided ring.

3. The pet collar of claim 2, wherein the first segment comprises a first terminus, and the first segment is directly coupled to the peripheral band proximate the first terminus

4. The pet collar of claim 3, wherein the second segment comprises a second terminus, and the second segment is directly coupled to the peripheral band proximate the second terminus.

5. The pet collar of claim 4, wherein the second segment further comprises a third terminus and a fastener, the fastener and the flat sided ring being different structures and the fastener being coupled to the second segment proximate the third terminus.

6. The pet collar of claim 5, wherein the flexible strap forms a closed loop and the flat or concave side faces an interior of the closed loop.

7. The pet collar of claim 6, wherein the peripheral band is elliptical, and a cross-section of the peripheral band is rectangular.

8. A method of using a pet collar, comprising:
providing a pet;
installing the pet collar of claim 1 on the pet, the flexible strap encircling a neck of the pet and the flat or concave side facing inwardly toward the pet.

9. The method of using a pet collar of claim 8, further comprising attaching a tether to the flat sided ring.

10. The method of using a pet collar of claim 9, wherein the pet is a dog.

11. The method of using a pet collar of claim 10, further comprising placing the flat-sided ring at a dorsal neck of the dog.

12. A method of using a pet collar, comprising:
providing a pet;
installing the pet collar of claim 5 on a pet, the flexible strap encircling a neck of the pet and the flat or concave side facing inwardly toward the pet.

13. 12. A method of using a pet collar, comprising:
providing a pet;
installing the pet collar of claim 7 on a pet, the flexible strap encircling a neck of the pet and the flat or concave side facing inwardly toward the pet.

14. A pet collar combination comprising:
a pet;
a pet collar, the pet collar encircling a neck of the pet, and comprising;
a flexible strap; and
a flat-sided ring, the flat-sided ring (i) being coupled to the flexible strap (ii), and comprising a peripheral band, the peripheral band having a flat or concave side, the flat or concave side facing inwardly toward the neck of the pet.

15. The pet collar combination of claim 14, wherein the flexible strap comprises a first segment and a second segment, each of the first and second segments being coupled directly to the flat-sided ring.

16. The pet collar of claim 15, wherein (i) the first segment comprises a first terminus, the first segment being directly coupled to the peripheral band proximate the first terminus, and (ii) the second segment comprises a second terminus, the second segment being directly coupled to the peripheral band proximate the second terminus.

17. The pet collar combination of claim 16, further comprising a tether, the tether being directly attached to the flat-sided ring.

18. The pet collar combination of claim 17, wherein the second segment further comprises a third terminus and a fastener, the fastener being coupled to the second segment proximate the third terminus.

19. A pet collar combination comprising:
a pet, the pet being a dog;
a pet collar, the pet collar encircling a neck of the pet, and comprising;
a flexible strap, the flexible strap comprising:
a first segment, the first segment consisting essentially of leather and a first terminus;
a second segment, the second segment consisting essentially of leather, a second terminus, and a third terminus;
a flat-sided ring, the flat-sided ring (i) being coupled to the first segment proximate the first terminus (ii), being coupled to the second segment proximate the second terminus, and (iii) comprising a peripheral band, the peripheral band circumscribing an elliptical aperture and having a rectangular cross-section.

20. The pet collar combination of claim 19, wherein the pet collar further comprises a fastener, the fastener and the flat-sided ring being different structures.
